(19) United States
(12) Patent Application Publication
(10) Pub. No.: US 2026/0088527 A1
(43) Pub. Date: Mar. 26, 2026

(54) CABLE CONNECTION DEVICE

(71) Applicant: HARTING Electric Stiftung & Co. KG, Espelkamp (DE)

(72) Inventor: Joachim KRAEMER, Kirchlengern (DE)

(21) Appl. No.: 18/992,479

(22) PCT Filed: Jul. 4, 2023
(86) PCT No.: PCT/DE2023/100506

§ 371 Date: Dec. 5, 2025

(30) Foreign Application Priority Data
Jul. 8, 2022 (DE) 10 2022 117 103.5

(51) Int. Cl. H01R 4/48

(52) U.S. Cl. CPC H01R 4/489

(57) ABSTRACT

A cable connection device comprising at least one contact support having a busbar with a contact portion and having a clamping element with a clamping arm acting upon the contact portion, wherein the contact portion of the busbar can be moved in relation to the clamping element on the contact support.

### CROSS REFERENCE TO RELATED APPLICATION

This application is a US National Phase application of PCT International Patent Application Serial No. PCT/DE2023/100506, Filed Jul. 4, 2023, which claims benefit to German Patent Application Serial No. 102022117103.5, filed Jul. 8, 2022, the contents of which are incorporated herein by reference.

### BACKGROUND OF THE INVENTION

The invention relates to a cable connection device. A cable connection device is usually embedded in an insulated housing and generally has a contact support with a busbar. For connecting an electrical conductor, the electrical conductor is usually clampingly fixed in the contact support, preferably to the busbar.

Clamping springs, in particular two-arm leg springs with a spring-elastic contact arm and with a more or less rigid bearing arm, are often used for the clamped fixing. The electrical conductor is clampingly fixed between the busbar and the contact arm. The contact arm acts as a clamping arm or clamping limb. The term “contact arm” selected here is intended to express that the electrical conductor has to be subjected to the clamping force of the contact arm in order to produce the permanent electrical contact of the conductor with the busbar.

In principle, the cable connection device serves to press the electrical conductor, for example a stranded wire or core of an electric cable inserted into the contact support, with the contact arm against the busbar and thus to connect it in an electrically conductive manner to the busbar and at the same time to hold it mechanically on the busbar. In the so-called “push-in” technique, the electrical conductor is simply inserted into a cable insertion opening on the contact support so that it is pushed between the clamping arm of the clamping spring and a contact portion of the busbar, and is clampingly fixed between the contact arm and this contact portion against being pulled out counter to its insertion direction. This “push-in” connecting technique is particularly user-friendly, since the manual effort is very small and can be carried out easily with two hands by the user.

However, the “push-in” technique requires a sufficiently rigid and stable electrical conductor. The individual wires of the cores have to be provided in sufficient numbers and to be sufficiently stiff or the core has to be provided with a ferrule. If a less stiff core without a ferrule is inserted, however, it can arise that it is not able to move, in particular to bend, the clamping limb of the clamping spring away from the contact portion of the busbar. In order to solve this problem, it is known to move the clamping limb away from the contact portion of the busbar using an external tool or an actuator and then to push the thin core between the clamping limb and the contact portion of the busbar. If the actuator is now released again, this thin core can also be fixedly clamped by the contact arm on the contact portion of the busbar, and electrically conductively connected and secured against being inadvertently pulled out. This can be implemented with two hands only with great difficulty, however, since the contact support and the cable have to be held at the same time and the actuator additionally has to be actuated, which would actually require three hands.

A spring force connection with a pivotably mounted leg spring is disclosed in WO 2018/153862 A1. A pivoting lever acts on the bearing limb of the leg spring. The bearing limb transfers the pivoting movement of the pivoting lever to a clamping limb of the leg spring so that the clamping limb can be moved away from the contact portion of the busbar, in order to open the clamping point between the contact portion and the clamping limb, so to speak. In addition to the contact portion and the clamping limb, a pivot bearing for the leg spring and the pivoting lever also have to be provided for actuating the leg spring, which appears to be structurally very complex.

A plug connector module with a connecting assembly is disclosed in DE 10 2020 119 129 A1. The connecting assembly in turn comprises a leg spring as a clamping element with a fixedly mounted bearing limb and a movable clamping limb. The clamping limb in turn is supported on a slide which is horizontally displaceable counter to the force of a restoring spring. The slide has a guide bevel on which a complementary configured guide bevel of a vertically displaceable actuator slides. The two guide bevels form a wedge thrust gear with one another so that a vertical movement of the actuator is transformed into a horizontal movement of the slide as a horizontal drive for the slide. The slide can thus be moved horizontally to and fro between two functional positions, namely a “push-in” position and an actuated position. In the “push-in” position the clamping limb of the leg spring bears against a contact portion of the busbar, while in the actuated position a slotted free space is left between the clamping limb and the contact portion. In the actuated position, therefore, a core or stranded wire can be inserted into the free space between the clamping limb and the contact portion without resistance, or the conductor can be removed again out of the contact support. The “push-in” position accordingly permits the connection of the conductor by simple insertion between the contact portion of the busbar and the clamping limb of the spring. In order to block the slide and thus the leg spring in the “push-in” position, the connecting assembly requires the spring pressure of the restoring spring. For blocking in the actuated position, a mechanical locking member engages behind the front edge of the slide which is displaced in the horizontal direction relative to the “push-in” position. This known connecting assembly requires very many parts, namely the actuator, the restoring spring and the locking member and a correspondingly large installation space in the cable connection device, in addition to the slide and the leg spring. Moreover, it is apparent that the vertically movable actuator arranged to the side of the slide can only be operated with great difficulty in the installed state.

### SUMMARY OF THE INVENTION

Proceeding therefrom, the object of the invention is to simplify the construction of a cable connection device.

In all of the known cable connection devices, the actuated position with the free space between the clamping element and the contact portion is implemented by the clamping element being moved out of its clamping position. Generally, as in the last-mentioned prior art, the clamping limb of the leg spring is pivoted into the actuated position either by means of a slide, an actuator or another tool. Relatively high spring forces have to be overcome. In addition, there is the risk that the spring force of the leg spring weakens when it remains for a long time in the actuated position. The present invention takes a completely different and novel approach:

According to the invention, the contact portion, on the one hand, and the clamping element, on the other hand, are designed to be movable relative to one another on the contact support. In this manner, the contact portion can easily be moved away from the clamping element. To this end, relatively small forces are required, which acts in a material-preserving manner. Moreover, the clamping element is not subjected to further load in the actuated position in which a slotted free space is left between the clamping element and the contact portion. The cable connection device can also be designed such that the clamping element is designed to be movable to and fro relative to the contact portion.

In a preferred embodiment, the contact portion and the clamping element are moved in a translational movement relative to one another. This can be implemented easily with simple guides on the contact support.

In a further advantageous embodiment, the contact portion and the clamping element are connected together by a locking mechanism. A conceivable model for such a locking mechanism is the pressure mechanism of a ballpoint pen. The pressure mechanisms of ballpoint pens are constructed such that the refill is retracted into the shaft of the ballpoint pen in its resting position and the refill protrudes from one end of the ballpoint pen in its writing position. A single actuation leads to a change, for example, from the resting position to the writing position. Further actuation which corresponds at least to the aforementioned actuation in the direction of movement, then leads again to the opposing change, i.e. in the aforementioned example from the writing position to the resting position.

Thus at the end there are preferably four noises or stops which are caused by the two actuations, i.e. the actuation for changing from the resting position to the writing position and back. The other two noises or stops are produced by the energy of the spring. The first actuation leads to the spring absorbing energy, wherein when released a locking geometry of the locking mechanism is pushed against a stop, which takes place by the spring. With a further introduction of force by the actuation, energy is stored again and the locking geometry or the locking mechanism is released from the stop and is pushed back by the spring in the direction of the initial position.

With the locking mechanism, it is possible to keep a free space between the contact portion of the busbar and the clamping arm of the clamping element free in the so-called actuated functional position of the locking mechanism, while in a second unactuated position of the “push-in” position the clamping arm of the clamping element bears against the contact portion of the busbar. The locking mechanism connecting the contact portion and the clamping element makes it possible in a very simple manner to move the contact portion and the clamping element relative to one another, in particular to displace in a translational manner, so that in each case the desired functional position can be selected in a simple and easy manner.

In a further advantageous embodiment, the locking mechanism is designed as a cam gear. To this end, a control arm is articulated either on the contact portion or on the clamping element. This control arm engages with its free end in a control cam. In the control cam, the control arm is movably guided via its free end. If the control arm is articulated on the contact portion, the control cam is arranged on the clamping element. If the control arm is arranged on the clamping element, however, the control cam is correspondingly located on the contact portion.

Particularly advantageous is a control cam with the geometry of a lower case letter d. The upper end of the vertical d-shaped bar serves as a starting point for the control arm in the control cam. The lower end of the vertical d-shaped bar accordingly serves as a turning point of the control cam. At the turning point the control arm transitions from the vertical d-shaped bar into the c-shaped arc arranged on the left-hand side on the d-shaped bar. The c-shaped arc thus serves as a return guide for the control arm to the starting point.

Particularly preferably, the geometry in the region of the c-shaped arc, when viewed from above, has a cone which serves for guiding the control arm. This means that the lower portion of the d in the transition between the vertical d-shaped bar to the c-shaped arc has no edge, whereas the upper transition between the c-shaped arc and the vertical d-shaped bar preferably has an edge. This serves for guiding the control arm since this control arm is twisted in the direction of the c-shaped arc and thus finds a path in the c-shaped arc and does not always only move in a translational manner.

Following the basic idea of the aforementioned pressure mechanism of the ballpoint pen, receiving contours, into which the free end of the control arm can snap, are configured both at the starting point of the control arm in the control cam and in the region of the turning point of the control arm in the cam. The receiving contour at the starting point of the control arm in the control cam corresponds to the aforementioned actuated position of the clamping element relative to the contact portion and the fixing of the control arm in the position at the turning point corresponds to the unactuated position, i.e. the “push-in” position of the contact portion and clamping element. In this manner, a secure blocking of the clamping element relative to the contact portion is ensured by simple means in the respectively selected functional position. The clamping element or the contact portion in the contact support can thus be switched to and fro in a simple manner.

The shape of the control cam is not limited to the described d-shape. In other embodiments, it is preferred that the control cam substantially forms a contour of an acute triangle with two guide bars, designed in a linear manner, and a locking position configured therebetween as a third side of the triangle. A pretensioning of the complementary control arm-alternatively a spring element-and ramps and radii configured in the contour can permit the transition between the respective positions. One of the guide bars is designed as a guide for the control arm from its starting point in the control cam at the point of intersection of the two guide bars to the locking position located between the guide bars, and the other of the guide bars is designed as a return guide for the control arm to the starting point in the control cam.

In a further advantageous embodiment, the contact portion is designed as a U-shaped contact cage in order to shield the contact point in an improved manner to the outside. A tab is also bent out from the contact cage on the contact portion, as an adaptor for the bearing arm. In a further advantageous embodiment, the clamping element is designed in the usual manner as a leg spring, wherein the leg spring has a clamping limb as a clamping arm which is resiliently movable relative to a bearing limb. Advantageously, a cam plate in which in turn the control cam is integrally formed is adapted at the free end of the bearing limb or bearing arm.

The cam plate on the bearing limb and the tab on the contact portion overlap one another in the position of the control arm at the turning point in the control cam and thus form, in addition to the U-shaped limbs of the contact portion, a further side wall of the contact cage and thus additionally shield the contact point advantageously to the outside.

Preferably, the cable connection device has a U-shaped contact cage as a contact portion with two side walls as U-shaped limbs and a contact plate which is configured therebetween on the U-shaped base, wherein the control cams of the locking mechanism are designed symmetrically on the outside on both side walls. A reliable relative movement of the contact portion and clamping element is implemented by the duplicated design.

A clamping element designed as a clamping holder which has the two control arms which are positioned and designed in a resilient manner and which engage from the outside in the control cams is also preferred.

Finally it is preferred that the contact portion and/or the clamping holder, preferably both, can be produced in one piece from sheet metal by cutting-bending and/or stamping operations. This achieves a simple production and a minimization of the number of components.

### BRIEF DESCRIPTION OF THE DRAWINGS

The invention is explained with further details by way of the exemplary embodiment shown in the figures of the drawing. In the drawing:

FIG. 1 shows a front view of a contact support in its “push-in” position,

FIG. 2 shows a view rotated by 180° of the contact support shown in FIG. 1 with a view of the rear face thereof with a cam plate adapted to the clamping element and with a fixed control arm at the turning point of the control cam,

FIG. 3 shows the contact support of FIG. 2 with the fixing of the control arm at the turning point released,

FIG. 4 shows the view of the contact support according to FIG. 3 with the control arm fixed at the starting point,

FIG. 5 shows the contact support shown in FIG. 4 rotated by 180° in a front view in the “actuated position”,

FIG. 6 shows the rear view of the contact support of FIG. 4 with the control arm released from the fixed position at the starting point during the movement of the control arm to the turning point,

FIG. 7 shows the view of FIG. 6 with the control arm moved shortly before reaching the turning point in the control cam,

FIG. 8 shows a further embodiment of a contact portion of a contact support,

FIG. 9 shows a further view of the contact portion shown in FIG. 8,

FIG. 10 shows a view of a clamping holder complementary to FIGS. 8 and 9 for completing the locking mechanism and

FIG. 11 shows a further view of the clamping holder of FIG. 10.

### DETAILED DESCRIPTION OF THE INVENTION

The figures contain partially simplified schematic views. Identical reference signs are used for parts which are identical and structurally the same. Different views of the same parts can be scaled differently.

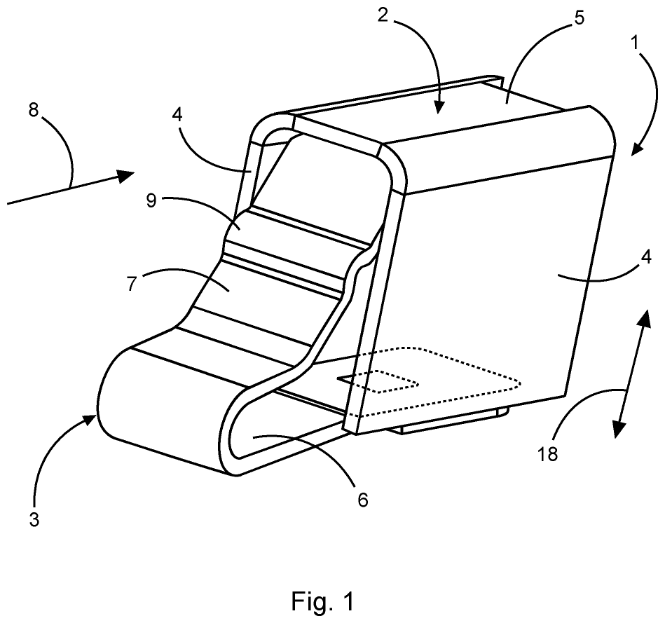

The contact support 1 according to the invention shown in FIG. 1 firstly has a contact portion 2 of a busbar and a clamping element 3 which is designed as a leg spring. The contact portion 2 is connected in a conventional manner to the remaining busbar, not shown in the figures of the drawing. In the exemplary embodiment, the contact portion 2 is constructed as a U-shaped contact cage with its U-shaped limbs as side walls 4 and with the contact plate 5 which connects the side walls 4 and which at the same time forms the U-shaped base of the U-shaped contact portion 2.

The leg spring acting as a clamping element 3 firstly consists of a bearing limb 6 and a clamping limb 7 which is resiliently mounted on the bearing limb 6. It can be identified that the free end of the clamping limb 7 bears against the lower face of the contact plate 5 of the contact portion 2. If a dimensionally stable conductor which is provided with a ferrule, not shown in the figures of the drawing, is inserted into the contact portion 2 in the conductor insertion direction 8, the clamping limb 7 springs downwardly in the direction of the bearing limb 6 and opens up a clamping space for the conductor which is defined by the side walls 4 and the contact plate 5 and the clamping limb 7. The clamping limb 7 then springs back in the direction of the contact plate 5, so that the conductor is inserted in a clamped manner in the clamping space. Additionally, a bead 9 is integrally formed in the clamping limb 7, said bead being designed to increase further the pressure of the clamping limb 7 on the conductor inserted in the clamping space, i.e. for improving the contact connection in the cable connection device according to the invention.

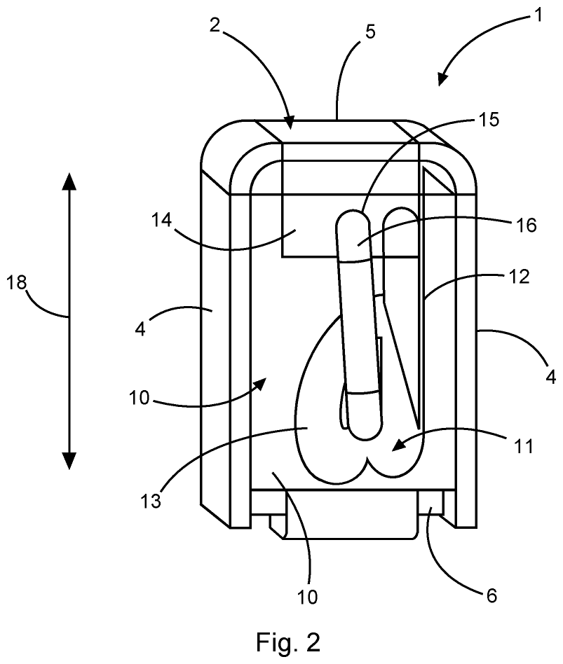

In the rear view of the contact support 1 of FIG. 1, shown in FIG. 2, the side walls 4 and the contact plate 5 of the contact portion 2 can be identified. Moreover, the front face of the free end of the bearing limb 6 of the leg spring acting as a clamping element 3 is visible. A cam plate 10 is adapted to the bearing limb 6. The cam plate 10 runs at right-angles to the bearing limb 6. A control cam 11 is integrally formed in the cam plate 10. The control cam 11 has, for example, the geometry of a lower case letter “d”. The control cam 11 thus consists of a vertical d-shaped bar 12 and a c-shaped arc 13 complementing the vertical d-shaped bar 12 to form the d-shaped contour.

A tab 14 which is bent back at right-angles out of the contact plate 5 of the contact portion 2 can also be identified. The tab 14 is penetrated by a bearing bore 15. The bearing end of a control arm 16 is incorporated in this bearing bore 15. In the exemplary embodiment, the control arm 16 has a cylindrical cross-sectional shape. The free end of the control arm 16 facing away from the bearing end penetrating the bearing bore 15 in turn engages in the control cam 11.

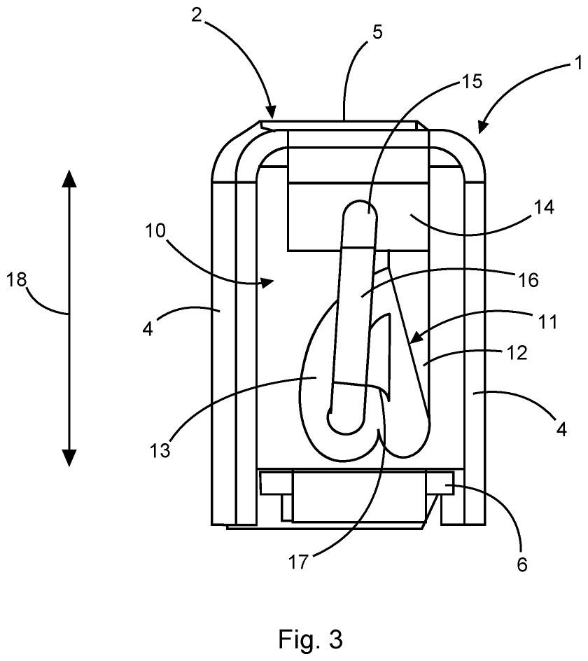

A receiving contour 17 which is complementary to the cross-sectional shape of the control arm 16 can be identified in the view of FIG. 3. The receiving contour 17 is substantially semi-circular and thus adapted to the cylindrical outer contour of the control arm 16. In the view of FIG. 2, the free end of the control arm 16 rests in the receiving contour 17. The control arm 16 is snapped, so to speak, with its free end into the receiving contour 17. Since the control arm 16 is connected in turn via the tab 14 to the contact portion 2, the control arm 16 thus holds the contact portion 2 in the “push-in” position of the contact support 1, shown in FIGS. 1 and 2. The contact portion 2 can be mounted against the pressure of a spring element, not shown in the drawings.

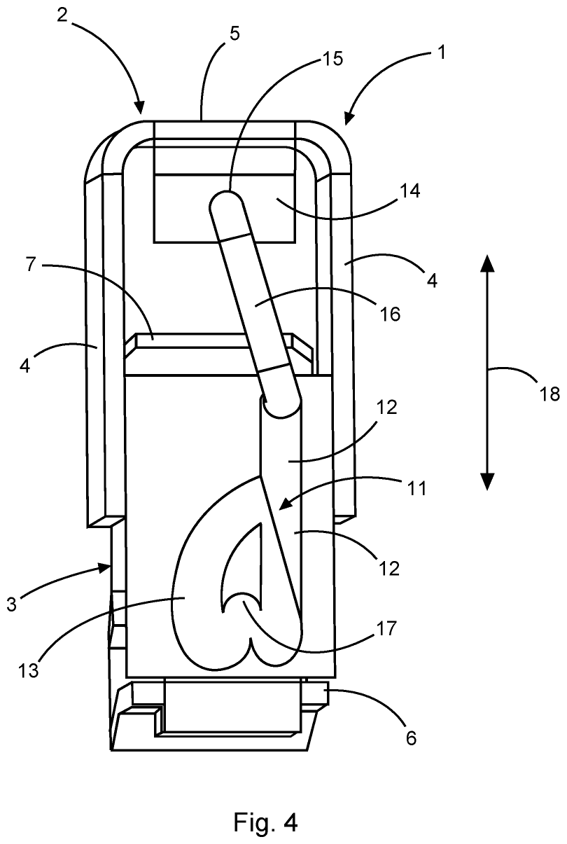

If the control arm 16 according to FIG. 3 is released from its snapped position in the receiving contour 17, and moves in the direction of the c-shaped arc 13 of the control cam 11, the free end of the control arm 16 releases the contact portion 2 at the same time so that it can move upwardly in a direction of movement 18 away from the clamping element 3 or the cam plate 10 which is shown in FIG. 4.

If the view of FIG. 3 and FIG. 4 is compared, it can be identified that starting from its position in FIG. 3 the free end of the control arm 16 initially passes through the c-shaped base of the control cam 11 upwardly in the direction of movement 18 in order then to merge with the vertical d-shaped bar of the control cam 11 and to move therein as far as the upper end. The upper end of the control cam 11 is also recessed in a semi-circular manner and thus forms a receiving contour for the free end of the control arm 16. The control arm 16 in its functional position, the “actuated” position shown in FIG. 4, is in turn snapped on, so to speak, at the end point of the control cam 11.

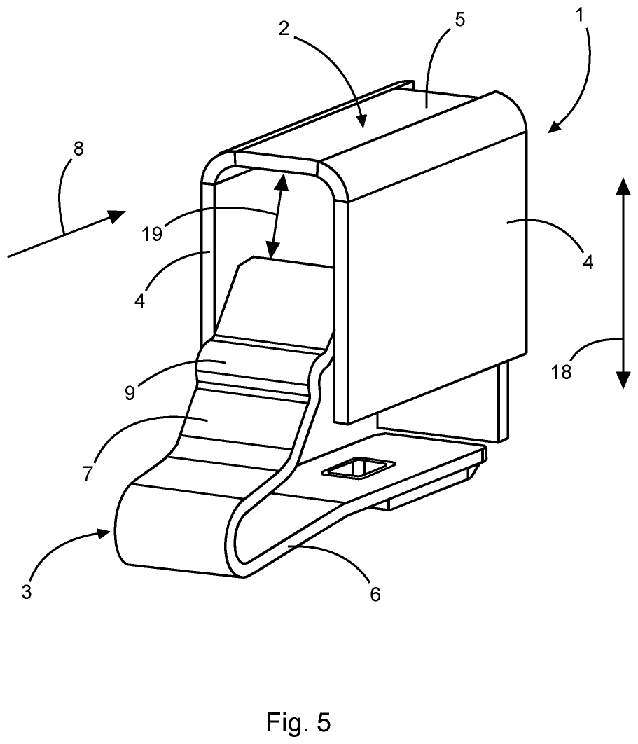

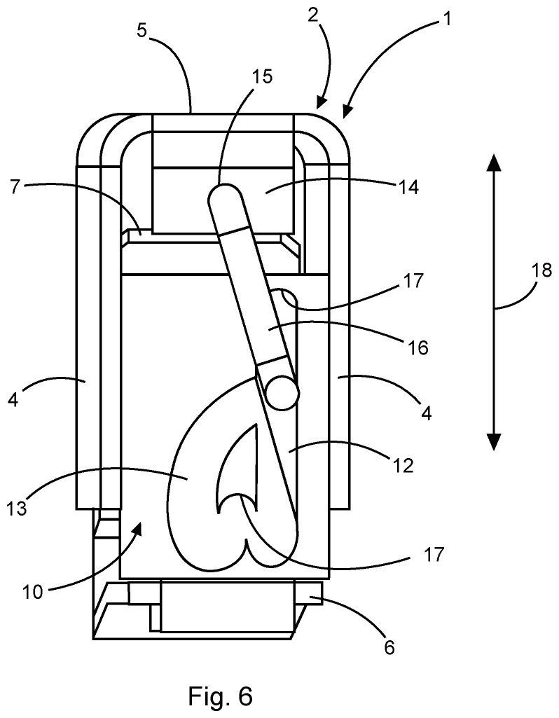

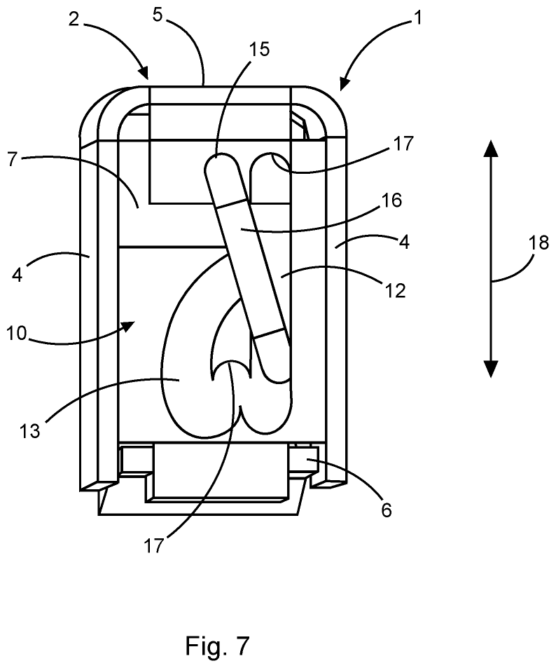

In the view of FIG. 4 it is possible to identify the front face of the free end of the clamping limb 7 of the clamping element 3 and also the front face of the bearing limb 6. FIG. 4 shows the contact support 1 with a view of its rear face in the same functional position as the view of FIG. 5 rotated by 180° relative to FIG. 4. The perspective of FIG. 5, the view of the front face, corresponds in turn to FIG. 1. If the two functional positions of the contact support 1 shown in FIGS. 1 and 5 are compared, it arises that in the view of FIG. 5 the contact portion 2 is displaced significantly upwardly relative to the clamping element 3 in the direction of movement 18, so that a clearly identifiable longitudinal spacing 19 is opened up between the free end of the clamping limb 7 of the clamping element 3 and the lower face of the contact plate 5. FIG. 5 shows the so-called “actuated position” of the contact support 1, while FIG. 1—as already mentioned-shows the so-called “push-in” position of the contact support 1. In the actuated position shown in FIG. 5, on the one hand, a conductor fixed in the contact support 1 can be pulled out and removed again from the contact support. The actuated position is thus used for dismantling a previously mounted conductor. Moreover, the actuated position serves for mounting conductors with non-dimensionally stable conductor ends, in particular conductor ends without ferrules.

In order to pass back from the actuated position shown in FIG. 4 and FIG. 5 to the “push-in” position, the contact portion 2 is simply pushed in the direction of movement 18 downwardly in the direction of the cam plate 10. The control arm 16 then travels downwardly in the vertical d-shaped bar 12 in the direction of movement 18 in order to reach ultimately its locking position again, shown in FIG. 2, in the receiving contour 17 at the turning point of the control cam 11.

In particular, the comparable view of FIG. 1 and FIG. 2, on the one hand, and FIG. 4 and FIG. 5, on the other hand, shows that with the contact support 1 according to the invention it is possible to switch very simply to and fro between the “push-in” position, on the one hand, and the “actuated” position, on the other hand, at least in an operation similar to the pressure mechanism of a ballpoint pen.

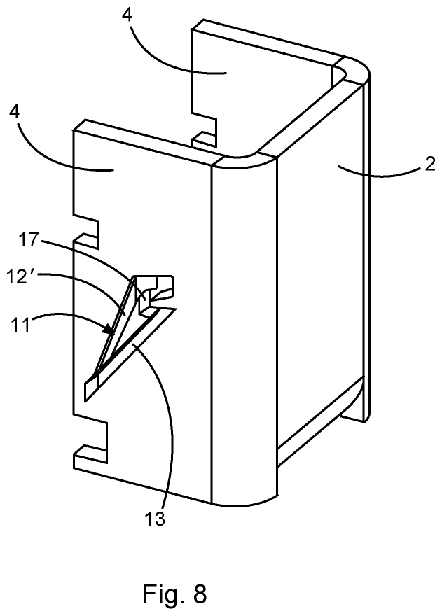

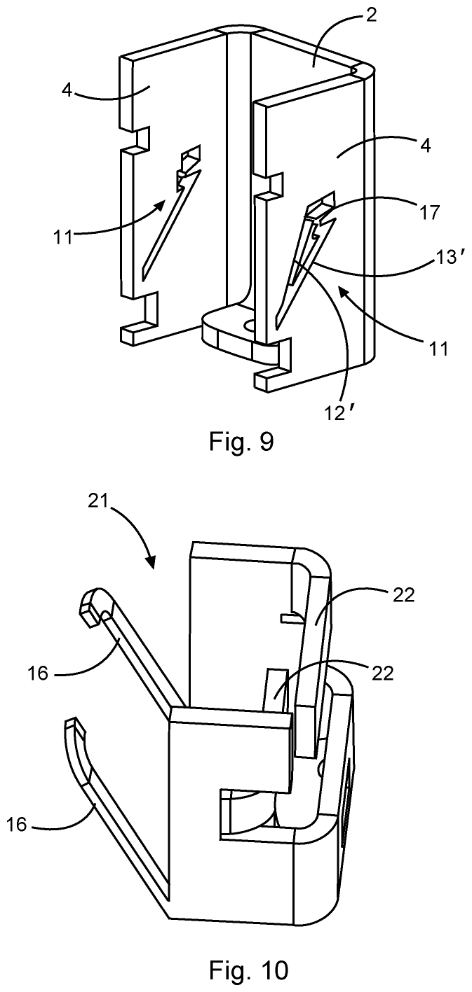

FIGS. 8 and 9 show an alternative embodiment in which the control cam 11 is configured in each case twice on side walls 4 of the contact portion 2. In this embodiment, the contact portion 2 has the function of holding the contact and transmitting the current.

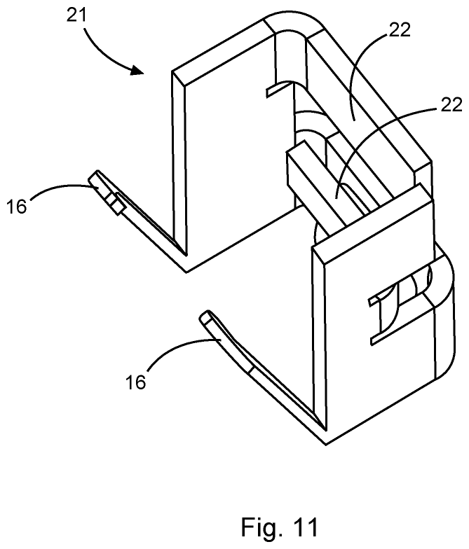

The control cams 11 are designed here to be less curved than in the first embodiment. The control arm, see FIGS. 10 and 11, is guided to a locking position in the receiving contour 17, the so-called “push-in” position of the contact support via a first actuating bar 12′, designed in a linear manner, of the control cam 11. By further actuation, the control arm is moved via a second actuating bar 13′, designed in a linear manner, of the control cam 11 back into the above-described actuated position.

In this embodiment, the actuating bar 13′ is cut out of the material and thus at this point there is no material. The actuating bar 12′ is stamped into the material, and the material thickness is thus smaller than at the surrounding points. This makes it possible for a guide portion 20, which has the full material thickness of the remaining side walls 4, to be configured between the two actuating bars 12′ and 13′. The stamped portions forming a ramp and a radius in the surroundings of the locking position in the receiving contour 17, can also be designed by being bent away in the direction of the opposing side surface 4 as an alternative to a stamped portion.

A clamping holder 21 which is complementary thereto is shown in FIGS. 10 and 11. The clamping holder 21 comprises two control arms 16 which are configured as inwardly and upwardly positioned arms. The control arms 16 take over the spring action in order to implement the locking mechanism, also denoted as the push-latch mechanism, in this embodiment. The free ends of the control arms 16 engage in the slotted guide of the control cams 11 which are shown in FIGS. 8 and 9.

Preferably a leg spring, not shown, is placed on the clamping holder 21 as a clamping element so that the clamping holder 21 itself can also be denoted as a clamping element. In particular, a bearing limb of the leg spring can be received between the clamping arms 22 of the clamping holder 21. Thus in this embodiment, in particular, a translational relative movement is also implemented between the clamping element and contact portion 2 by the actuation of the push-latch mechanism.

Both the contact portion 2 and the clamping holder 21 are preferably produced from sheet metal, simply by using cutting-bending and/or stamping operations, so that the production requires few working steps and can be easily automated.

The contour of the control cam 11 can be exchanged between the embodiments, and thus the control cam 11 shown in FIG. 8 can also be used instead of the rounded control cam 11 shown in FIG. 2, for example, and vice versa.

In addition, the embodiment of FIGS. 8 to 11 is also provided with only one control cam 11 and a complementary control arm 16, for example by only one corresponding control cam 11 being integrally formed on only one of the side surfaces 4.

1. A cable connection device comprising at least one contact support having a busbar with a contact portion and having a clamping element with a clamping arm configured to act upon the contact portion,
wherein
the contact portion of the busbar is moveable in relation to the clamping element on the contact support.

2. The cable connection device as claimed in claim 1,
wherein
a translational movement between the contact portion and the clamping element.

3. The cable connection device as claimed in claim 1,
wherein
a locking mechanism connects the contact portion and the clamping element.

4. The cable connection device as claimed in claim 3,
wherein
a first actuated functional position of the locking mechanism with a free space between the contact portion of the busbar and the clamping arm of the clamping element and by a second unactuated functional position of the locking mechanism with a clamping arm of the clamping element bearing against the contact portion of the busbar.

5. The cable connection device as claimed in claim 3,
wherein
the locking mechanism is configured as a cam gear such that a control arm articulated on the contact portion or on the clamping element engages with its free end in a control cam arranged on the clamping element or on the contact portion and is movably guided in the control cam.

6. The cable connection device as claimed in claim 5,
wherein
the control cam has substantially the shape of a lower case letter d with the vertical d-shaped bar as a guide for the control arm from its starting point in the control cam at the upper end of the d-shaped bar to the turning point of the control cam at the lower end of the d-shaped bar and with the c-shaped arc arranged on the left-hand side in the lower region of the d-shaped bar as a return guide for the control arm to the starting point in the control cam, or
in that the control cam has substantially a contour of an acute triangle with two guide bars, designed in a linear manner, and a locking position configured therebetween as a third side of the triangle, wherein one of the guide bars is designed as a guide for the control arm from its starting point in the control cam at the point of intersection of the two guide bars to the locking position located between the guide bars, and the other of the guide bars is designed as a return guide for the control arm to the starting point in the control cam.

7. The cable connection device as claimed in claim 6,
wherein
a receiving contour which is complementary to the geometry of the control arm at the starting point of the control arm in the control cam and a further receiving contour which is complementary to the geometry of the control arm at the turning point of the control arm in the control cam for the releasable fixing of the control arm in its respective position in the control cam.

8. The cable connection device as claimed in claim 1,
wherein
a U-shaped contact cage as a contact portion with a tab which is bent out from the U-shaped base and which runs at right-angles to the U-shaped limbs, with a bearing bore receiving the bearing end of the control arm as a point of articulation for the control arm on the contact portion.

9. The cable connection device as claimed in claim 1,
wherein
a leg spring as a clamping element with a clamping limb as a clamping arm, the free end thereof clampingly fixing to the contact portion the end of the conductor to be connected, and with a bearing limb, a cam plate with the control cam being adapted at the free end thereof.

10. The cable connection device as claimed in claim 9,
wherein
the cam plate on the bearing limb and the tab on the contact portion overlap one another in the position of the control arm at its turning point in the control cam.

11. The cable connection device as claimed in claim 3,
wherein
a U-shaped contact cage as a contact portion with two side walls as U-shaped limbs and a contact plate which is configured therebetween on the U-shaped base, wherein control cams of the locking mechanism are designed symmetrically on the outside on both side walls.

12. The cable connection device as claimed in claim 11,
wherein
a clamping element which is designed as a clamping holder and which has the two control arms which are positioned and designed in a resilient manner and which engage from outside in the control cams.

13. The cable connection device as claimed in claim 12,
wherein
the contact portion and/or the clamping holder, are produced in one piece from sheet metal by cutting-bending and/or stamping operations.

14. The cable connection device as claimed in claim 2,
wherein
a locking mechanism connects the contact portion and the clamping element.

15. The cable connection device as claimed in claim 14,
wherein
a first actuated functional position of the locking mechanism with a free space between the contact portion of the busbar and the clamping arm of the clamping element and by a second unactuated functional position of the locking mechanism with a clamping arm of the clamping element bearing against the contact portion of the busbar.

16. The cable connection device as claimed in claim 4,
wherein
the locking mechanism is configured as a cam gear such that a control arm articulated on the contact portion or on the clamping element engages with its free end in a control cam arranged on the clamping element or on the contact portion and is movably guided in the control cam.

17. The cable connection device as claimed in claim 16,
wherein
the control cam has substantially the shape of a lower case letter d with the vertical d-shaped bar as a guide for the control arm from its starting point in the control cam at the upper end of the d-shaped bar to the turning point of the control cam at the lower end of the d-shaped bar and with the c-shaped arc arranged on the left-hand side in the lower region of the d-shaped bar as a return guide for the control arm to the starting point in the control cam, or
in that the control cam has substantially a contour of an acute triangle with two guide bars, designed in a linear manner, and a locking position configured therebetween as a third side of the triangle, wherein one of the guide bars is designed as a guide for the control arm from its starting point in the control cam at the point of intersection of the two guide bars to the locking position located between the guide bars, and the other of the guide bars is designed as a return guide for the control arm to the starting point in the control cam.

18. The cable connection device as claimed in claim 14,
wherein
the locking mechanism is configured as a cam gear such that a control arm articulated on the contact portion or on the clamping element engages with its free end in a control cam arranged on the clamping element or on the contact portion and is movably guided in the control cam.

19. The cable connection device as claimed in claim 18,
wherein
the control cam has substantially the shape of a lower case letter d with the vertical d-shaped bar as a guide for the control arm from its starting point in the control cam at the upper end of the d-shaped bar to the turning point of the control cam at the lower end of the d-shaped bar and with the c-shaped arc arranged on the left-hand side in the lower region of the d-shaped bar as a return guide for the control arm to the starting point in the control cam, or
in that the control cam has substantially a contour of an acute triangle with two guide bars, designed in a linear manner, and a locking position configured therebetween as a third side of the triangle, wherein one of the guide bars is designed as a guide for the control arm from its starting point in the control cam at the point of intersection of the two guide bars to the locking position located between the guide bars, and the other of the guide bars is designed as a return guide for the control arm to the starting point in the control cam.
